(19) United States
(12) Patent Application Publication
(10) Pub. No.: US 2019/0168833 A1
(43) Pub. Date: Jun. 6, 2019

(54) VEHICLE PANEL MOUNTING DEVICE AND METHOD OF USING THE SAME

(71) Applicant: Honda Motor Co., Ltd., Tokyo (JP)

(72) Inventor: Tristan William Hollar, Trussville, AL (US)

(21) Appl. No.: 15/829,299

(22) Filed: Dec. 1, 2017

(51) Int. Cl. B62D 65/02; B62D 65/06

(52) U.S. Cl. CPC B62D 65/026; B62D 65/06

(57) ABSTRACT

A vehicle panel mounting jig includes a first block assembly having a first arm extending substantially perpendicularly at a first mounting jig end, and a second block assembly having a second arm extending substantially perpendicularly at a second mounting jig end and also an opening defined within an inside second block end wherein an inside first block end of the first block assembly is configured for placement therein. The first block assembly and the second block assembly are coupled with an internal tension device. Each of the first arm and the second arm may include a notch formed on an inside radius, and one of the block assemblies may include a handle extending at either the first mounting jig end or the second mounting jig end.

### BACKGROUND

Movable body panels of a vehicle (e.g., doors, hoods, trunk lids, and tailgates) are typically mounted to a vehicle body with one or more hinges. The hinges are generally attached to the vehicle panel and the vehicle body using fasteners, which may include bolts or welds. In a vehicle assembly process the vehicle panel can be installed by automated means, such as a robot, or installed manually by manufacturing associates. When installed by automated means, robots and jigs can be designed and optimized to place and hold the vehicle panel and hinges in a desired position with respect to the vehicle body while simultaneously fastening the mounting bolts to secure the vehicle panel to the vehicle body. However, when installed manually the manufacturing associate is often tasked with both ensuring proper positioning of the component and tightening the fasteners. This process can be difficult for the manufacturing associate when manipulating a large vehicle panel or fastening bolts in locations that are difficult to reach.

Current practice in the automotive manufacturing industry when manually installing a movable vehicle panel onto a vehicle body is to use a model-specific mounting jig to assist the manufacturing associate in holding the vehicle panel in its intended position while the manufacturing associate tightens the fasteners and/or completes the welds. However, these mounting jigs are often expensive, complex, have limited usage, and can remain deficient in overall functionality. The jigs are generally designed for application to vehicle models contained in a single model line and having a similar vehicle body and vehicle panel, necessitating multiple jigs for manufacturing plants having multiple model lines. Despite the complex nature of these jigs, they may still lack adequate retention force for holding the vehicle panel in the proper position against the vehicle body while the manufacturing associate is installing fasteners.

### BRIEF SUMMARY

According to one aspect, a vehicle panel mounting jig includes a first block assembly, a first arm extending from the first block assembly, a second block assembly, a second arm extending from the second block assembly, and a tension device. The first block assembly includes an outside first block end and an inside first block end, wherein a longitudinal axis of the mounting jig is defined as extending between the outside first block end and the inside first block end of the first block assembly. The second block assembly includes an outside second block end and an inside second block end. The first arm extends substantially perpendicularly from the outside first block end of the first block assembly, and the second arm extends substantially perpendicularly from the outside second block end of the second block assembly. The inside second block end of the second block assembly defines an opening wherein the inside first block end of the first block assembly is configured for placement within the opening and to slide along the longitudinal axis relative to the second block assembly. The tension device couples the first block assembly and the second block assembly.

According to another aspect, a mounting jig for temporarily retaining a vehicle panel onto a vehicle body includes a base block assembly, an extension assembly, and an extension spring. The base block assembly includes a first arm configured to insert into an aperture defined by a first edge surface within the vehicle body. The extension assembly includes an end that defines an opening configured to receive an end of and slide longitudinally relative to the base block assembly, a handle, and also a second arm configured to insert into an aperture defined by a second edge surface within the vehicle panel. The extension spring is located within an internal cavity of the mounting jig and is coupled to the base block assembly at a first mounting jig end, and the extension assembly at a second mounting jig end.

According to a further aspect, a method for securing a vehicle panel to a vehicle body includes placing the vehicle panel in a mounting position on the vehicle body and temporarily securing the vehicle panel to the vehicle body. Temporarily securing the vehicle panel to the vehicle body includes aligning a first arm located on a first mounting jig end of a mounting jig with a first aperture defined by a first edge surface within the vehicle body and inserting the first arm into the first aperture, and aligning a second arm located on a second mounting jig end of the mounting jig with a second aperture in the vehicle panel and inserting the second arm into the second aperture.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a rear view of a vehicle panel attached to a vehicle body in an open configuration.

FIG. 2 is a perspective view of the vehicle panel shown in FIG. 1 in a mounting position on the vehicle body.

FIG. 3 is a perspective view of an exemplary embodiment of a mounting jig temporarily holding the vehicle panel shown in FIG. 1 on the vehicle body.

FIG. 4 is a perspective view of a door hinge in a position for fastening to a vehicle body.

FIG. 5 is a perspective view of the mounting jig shown in FIG. 3.

FIG. 6 is a sectional view of Section A-A of the mounting jig shown in FIG. 5.

FIG. 7 is a side view of the mounting jig shown in FIG. 5 in a fully compressed state.

FIG. 8 is a side view of the mounting jig shown in FIG. 5 in a partially extended state.

FIG. 9 is a side view of the mounting jig shown in FIG. 5 in a fully extended state.

FIG. 10 is a method of temporarily securing a vehicle panel onto a vehicle body according to an exemplary embodiment.

### DETAILED DESCRIPTION

### Description

With reference now to the figures wherein the illustrations are for purposes of illustrating one or more exemplary embodiments and not for purposes of limiting the same, there is shown a vehicle panel mounting jig and method of using the mounting jig.

### DRAWINGS

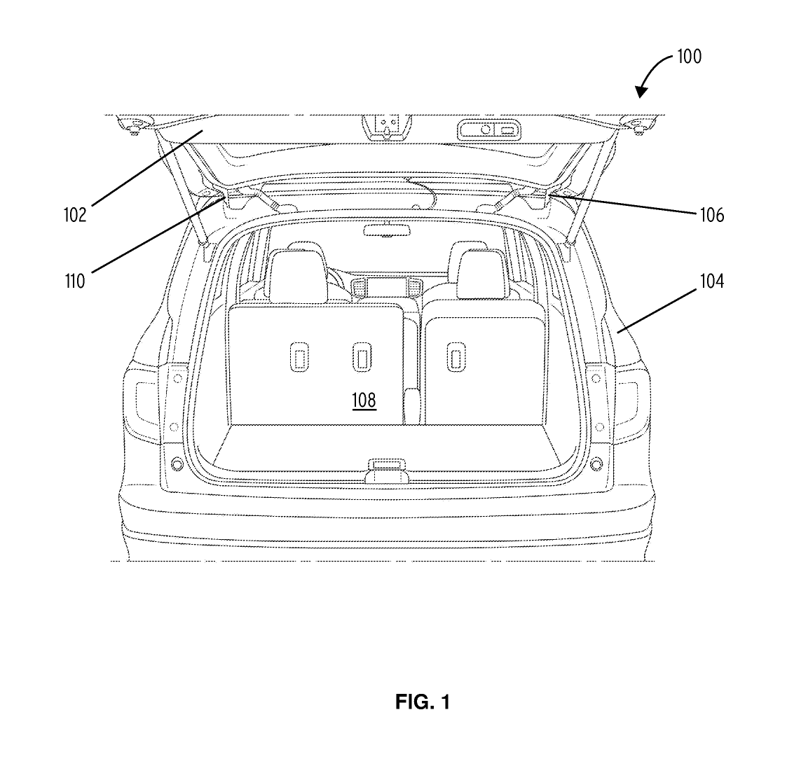

FIG. 1 is a rear view of an exemplary vehicle 100. In the exemplary embodiment, the vehicle 100 includes a movable vehicle panel 102 and a vehicle body 104. FIG. 1 shows the vehicle panel 102 in an open configuration with respect to the vehicle body 104. The vehicle panel 102 provided is a tailgate, however the vehicle panel 102 in other embodiments may comprise a door, hood, trunk lid, or other vehicle component that attaches to the vehicle body 104 in a swinging configuration. The vehicle 100 includes a first door hinge 106 and a second door hinge 110 that each hingedly couple the vehicle panel 102 and the vehicle body 104. The first door hinge 106 will be described further, however it is understood that this description also applies to the second door hinge 110 as well any additional door hinges that may be present in further embodiments. The first door hinge 106 fastens to the vehicle panel 102 at one end using one or more bolts, and also fastens to the vehicle body 104 at a second end using one or more bolts. Alternatively, the first door hinge 106 may be welded, riveted, or fastened to the vehicle panel 102 and vehicle body 104 using other known fastening devices. The first door hinge 106, as shown in FIG. 1, may be configured such that the vehicle panel 102 is able to move in a rotating motion relative to the vehicle body 104, with the first door hinge 106 located at or near a center of a rotational axis. The rotating motion allows the vehicle panel 102 to move between a closed configuration and the open configuration shown in FIG. 1, and provide a person with access to an interior volume 108 of the vehicle body 104. Two or more door hinges 106, 110 may be used in a typical configuration to attach a vehicle panel 102 to a vehicle body 104.

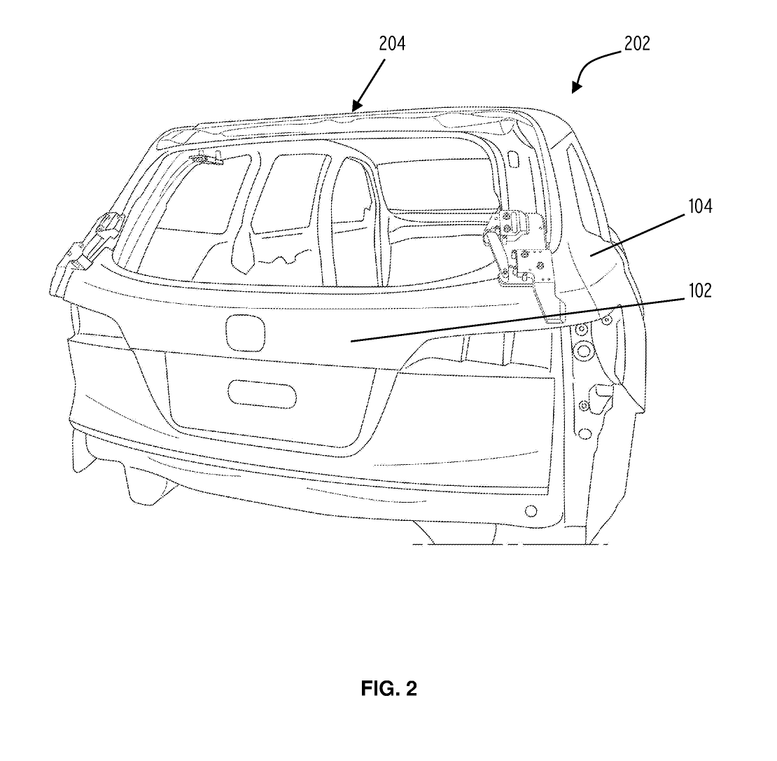

FIG. 2 is a perspective view of the exemplary vehicle 100. FIG. 2 shows the vehicle panel 102 in a mounting position 202 with respect to the vehicle body 104. The mounting position 202 may be a closed configuration of the vehicle panel 102 at a location on the vehicle body 104 where the vehicle 100's manufacturer intends the vehicle panel 102 be installed. In other embodiments, the mounting position 202 may be a partially open configuration wherein the vehicle panel 102 is ajar relative to the vehicle body 104. The mounting position 202 provides a manufacturing associate with clear access to through holes within the first door hinge 106 where bolts may be inserted to fasten the vehicle panel 102 to mounting holes within the vehicle body 104. As provided in FIG. 2, the mounting holes may be located on a substantially horizontal surface at an outer upper rear area 204 of the vehicle body 104. In a typical assembly operation, the first door hinge 106 may be fastened to the vehicle panel 102 prior to the assembly configuration depicted in FIG. 2, as the location where the first door hinge 106 fastens to the vehicle panel 102 may not be clearly accessible to the manufacturing associate with the vehicle panel 102 in the mounting position 202.

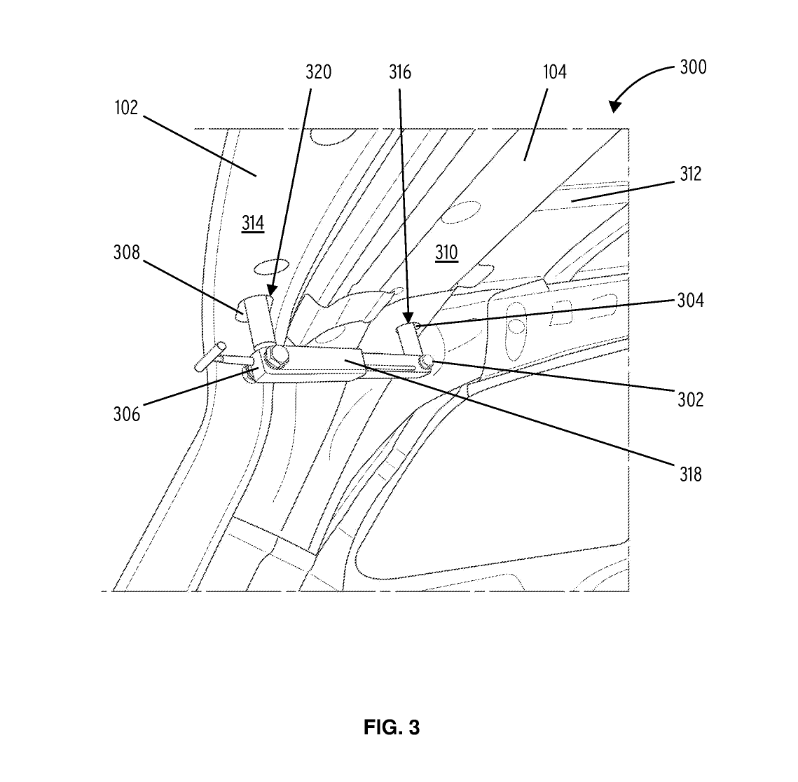

FIG. 3 is a perspective view of an exemplary embodiment of a vehicle panel mounting jig 318. In the exemplary embodiment, the mounting jig 318 is temporarily securing the vehicle panel 102 in the mounting position 202 with respect to the vehicle body 104. A first mounting jig end 302 of the mounting jig 318 may engage a first edge surface 316 defining a first aperture 304 located within an interior surface 310 of a roof panel 312 of the vehicle body 104, and a second mounting jig end 306 of the mounting jig 318 may engage a second edge surface 320 defining a second aperture 308 located within a corresponding adjacent surface 314 of the vehicle panel 102. The first edge surface 316 will be described further, however it is understood that this description also applies to the second edge surface 320. The vehicle panel 102 may initially be manually held in the mounting position 202 by a first hand of the manufacturing associate while the mounting jig 318 is installed by a second hand to temporarily hold the vehicle panel 102 on the vehicle body 104 in the mounting position 202, allowing the manufacturing associate to release the vehicle panel 102 with the first hand and perform other tasks such as fastening the door hinge 106 to the vehicle body 104.

The first edge surface 316 has a thickness that may correspond to a thickness of material from which each of the vehicle panel 102 and the vehicle body 104 are formed. Alternatively, the first edge surface 316 may correspond to a thickness greater than the thickness of material, for example if the first aperture 304 is defined in an area of multiple layers of stacked or folded material.

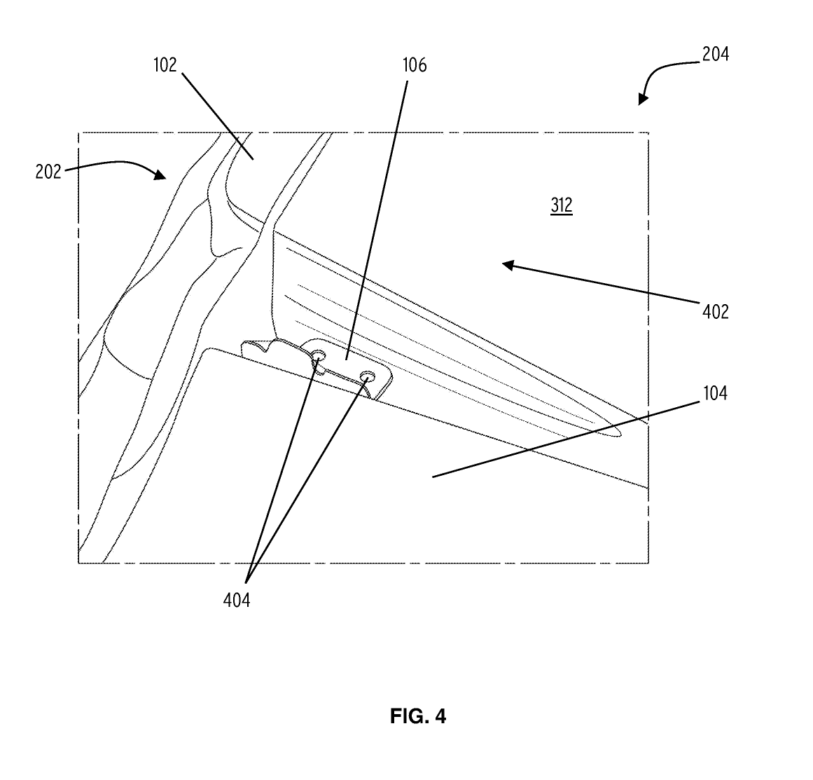

FIG. 4 is a perspective view of the first door hinge 106. FIG. 4 shows the first door hinge 106 in an exemplary environment at an outer upper rear area 204 of the vehicle body 104 wherein one end of the first door hinge 106 is positioned for mounting to an exterior surface 402 of the roof panel 312 of the vehicle body 104. As depicted in FIG. 4, the first door hinge 106 may be pre-fastened to the vehicle panel 102 at a second end (not shown). The vehicle panel 102 is in the mounting position 202 to allow clear access to a through hole 404 at the end of the first door hinge 106 that fastens to the vehicle body 104. A bolt (not shown) may be inserted through the through hole 404 and into a corresponding mounting hole (not shown) defined in the vehicle body 104 to fasten the first door hinge 106 and vehicle panel 102 to the vehicle body 104.

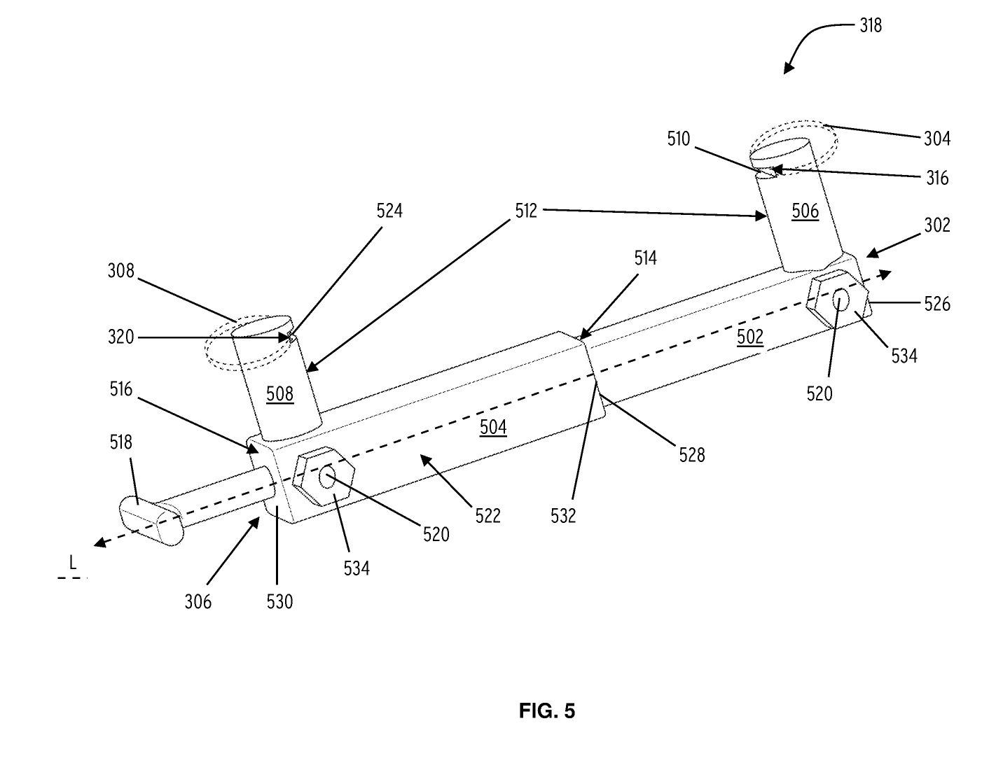

FIG. 5 is a perspective view of the mounting jig 318. The mounting jig 318 includes a first block assembly 502 and a second block assembly 504. Each block assembly 502, 504 has a hollow internal cavity and may have a square cross-section (e.g., a section of square tubing), or alternatively may have a circular cross-section (e.g., a section of round tubing). Each block assembly 502, 504 may be comprised of metal or plastic, such that it has sufficient rigidity to apply clamping force necessary to hold the vehicle panel 102 to the vehicle body 104.

The first block assembly 502 includes a first arm 506 that perpendicularly extends from a first mounting jig end 302 of the mounting jig 318. The second block assembly 504 includes a second arm 508 that perpendicularly extends from a second mounting jig end 306 of the mounting jig 318. Each arm 506, 508 is substantially cylindrical in shape and may be hollow (e.g., a section of round pipe) or solid (e.g., a section of round bar stock). The first arm 506 may include a first notch 510 that is alignable with the first edge surface 316, and the second arm 508 may include a second notch 524 that is alignable with the second edge surface 320. The first notch 510 and second notch 524 are located on an inside radius 512 of the each respective arm 506, 508 with respect to the mounting jig 318. For example, if the first arm 506 includes the first notch 510 and the second arm 508 includes the second notch 524, the first notch 510 and the second notch 524 will face one another. The depth of each notch 510, 524 may be between ⅛ and ½ the diameter of each respective arm 506, 508; the height of each notch 510, 524 is greater than the thickness of the edge surface 316, 320 to which it is intended to engage.

The first block assembly 502 includes an outside first block end 526 that corresponds to the first mounting jig end 302, and an inside first block end 528. A longitudinal axis L extends between the outside first block end 526 and the inside first block end 528. The second block assembly 504 includes an outside second block end 530 that corresponds to the second mounting jig end 306, and an inside second block end 532. The inside second block end 532 of the second block assembly 504 defines an opening 514 wherein the inside first block end 528 is configured for placement therein. The second block assembly 504 is also configured such that it may freely slide in a longitudinal direction along the longitudinal axis L relative to the first block assembly 502.

The mounting jig 318 may also include a handle 518 to facilitate ease of use. The handle 518 may be located on either the first mounting jig end 302 or the second mounting jig end 306, and on either a transverse face 516 or a longitudinal face 522. In the embodiment depicted in FIG. 5, the handle 518 is located on a transverse face 516 of the second block assembly 504. The handle 518 is configured such that it may be grasped by the manufacturing associate to apply a tension force to the mounting jig 318 to extend it in order to align, for example, the second arm 508 with the second aperture 308 in the vehicle panel 102.

The mounting jig 318 may also include a retention bolt 520 to retain one end of an internal tension device, as described later, at the first mounting jig end 302, and a second end of the internal tension device at the second mounting jig end 306.

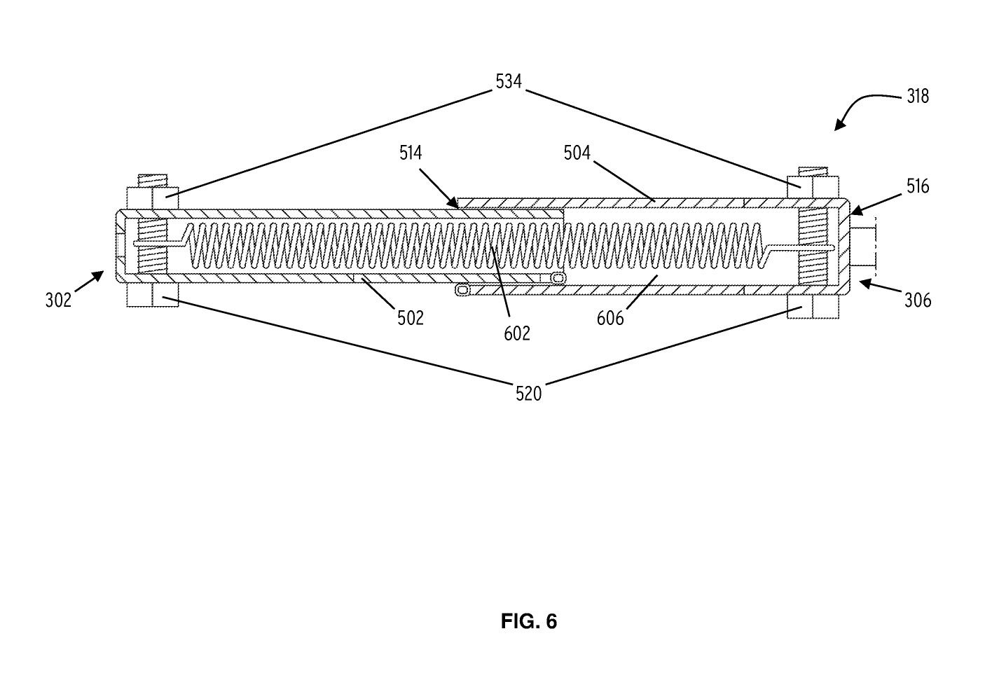

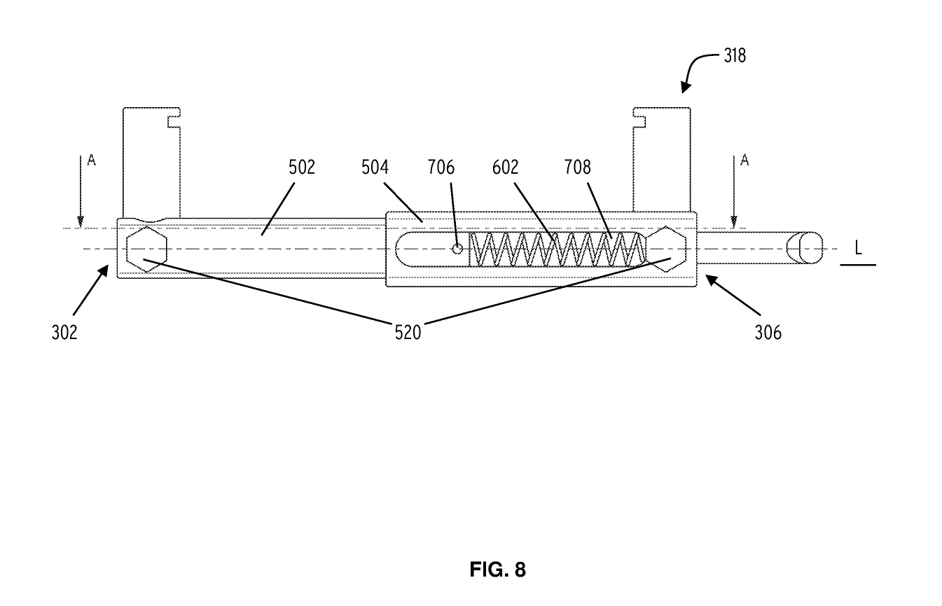

FIG. 6 is a sectional view of Section A-A in FIG. 8. As shown in FIG. 6, the mounting jig 318 may include an internal tension device 602 that couples the first mounting jig end 302 of the mounting jig 318 at the first block assembly 502 to the second mounting jig end 306 of the mounting jig 318 at the second block assembly 504. The tension device 602 may comprise an extension spring, as shown, or alternatively may comprise an elastic band, hydraulic cylinder, pneumatic cylinder, or other object that can apply a tension force to compress the mounting jig 318. The tension device 602 may be coupled to the first mounting jig end 302 and the second mounting jig end 306 of the mounting jig 318 using the retention bolt 520 and further secured using the nut 534. The tension device 602 may be fully contained within an internal cavity 606 of the mounting jig 318, and may be removed and replaced with a different tension device having the same or a different tension force in order to achieve a desired compression force for the mounting jig 318 as needed for a specific application.

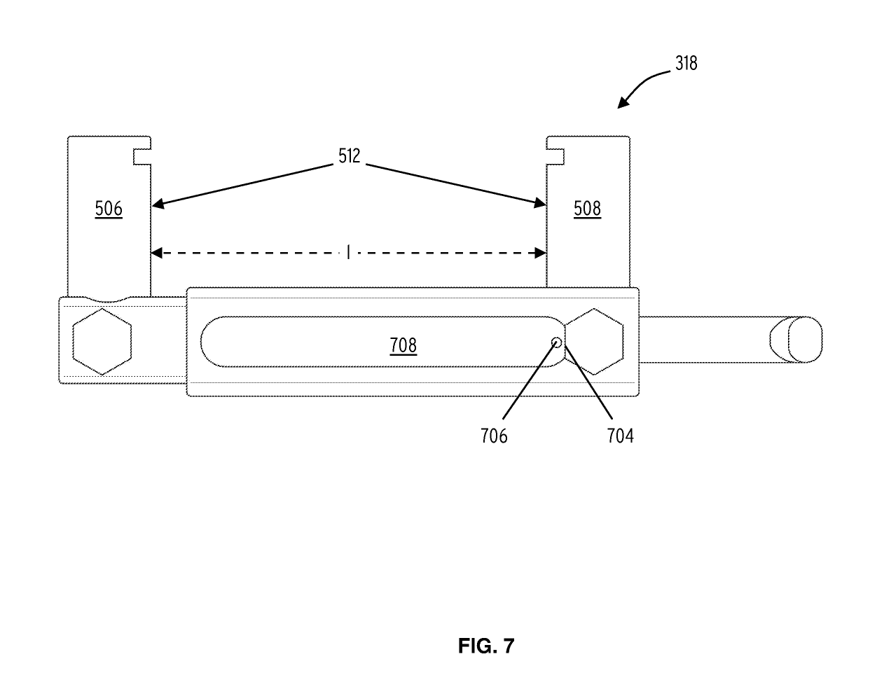

FIG. 7 is an exemplary embodiment of the mounting jig 318 in a fully compressed state. A compressed arm distance 1 indicates a distance between the inside radius 512 of each of the first arm 506 and the second arm 508 with the mounting jig in the fully compressed state. The mounting jig 318 may include a protuberance 706 extending from a surface of the first block assembly 502, along with a slot aperture 708 defined within the second block assembly 504 and located at a position corresponding to the position of the protuberance 706. The protuberance 706 is located within the slot aperture 708 in order to limit the extent of relative movement between the first block assembly 502 and the second block assembly 504 along the longitudinal axis L. The protuberance 706 may comprise a bolt head or other removable object to allow for removal and separation of the first block assembly 502 and the second block assembly 504 as needed, such as for service or repair. When the mounting jig 318 is in the fully compressed state, the protuberance 706 is located at a surface defining a second slot end 704.

FIG. 8 is a side view of the mounting jig 318 in a partially extended state. The internal tension device 602 is visible through the slot aperture 708 within the second block assembly 504. As previously indicated, the ends of the tension device 602 are retained at each of the first mounting jig end 302 and the second mounting jig end 306 by a bolt 520. A section line A-A is provided to define the sectional view provided in FIG. 6.

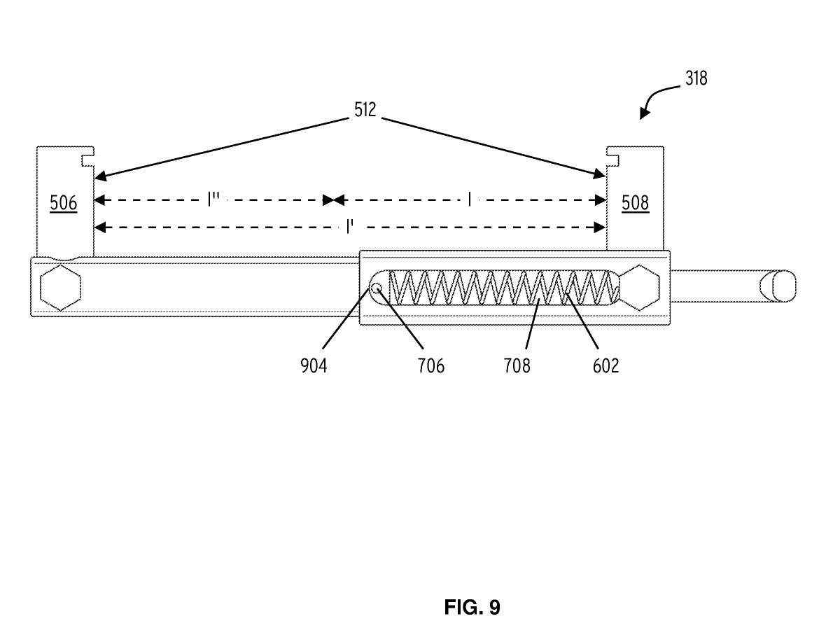

FIG. 9 is an exemplary embodiment of the mounting jig 318 in a fully extended state. When the mounting jig 318 is in the fully extended state, the protuberance 706 is located at a surface defining a first slot end 904. The protuberance 706 limits the extent of extension and compression of the mounting jig 318 by providing a physical stop against each of the first slot end 904 and the second slot end 704. An extended arm distance 1′ indicates a distance between the inside radius 512 of each of the first arm 506 and the second arm 508 with the mounting jig 318 in the fully extended state. The extended arm distance 1′ is greater than the compressed arm distance 1 by a working distance 1″ that may be equal to the length of the slot aperture 708 less the width of the protuberance 706. In addition to limiting longitudinal movement, the visible location of the protuberance 706 within the slot aperture 708 provides the manufacturing associate with a visible indication of the current elongation position of the mounting jig 318.

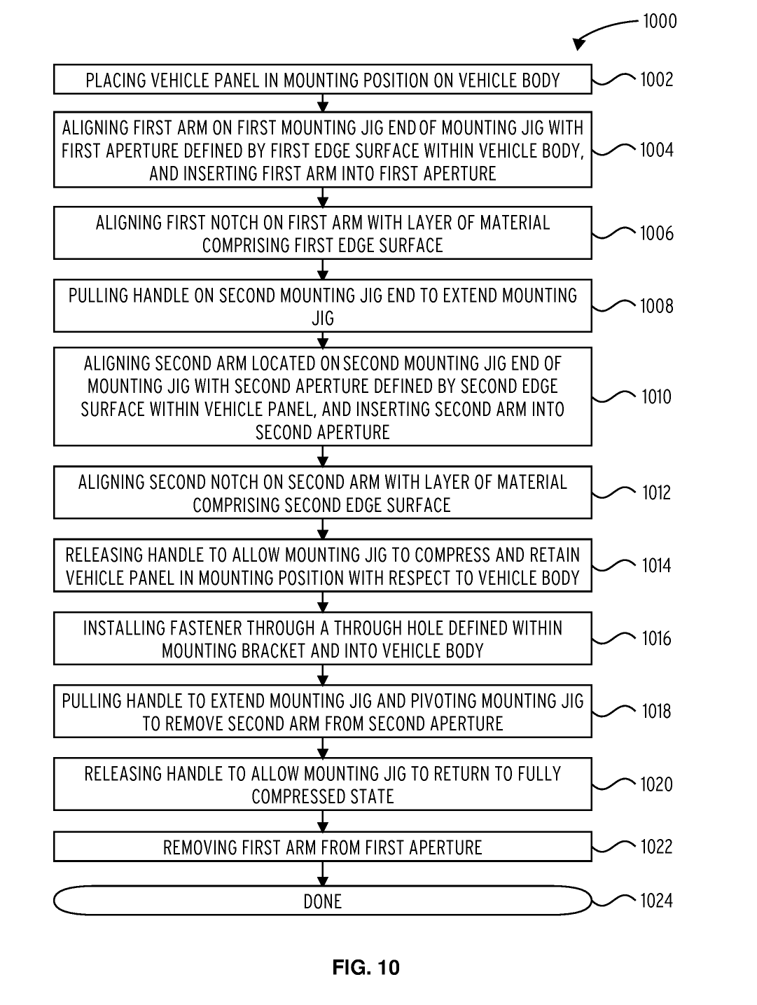

FIG. 10 is a method of installing a vehicle panel onto a vehicle body. In an exemplary embodiment, method 1000 includes placing 1002 a vehicle panel in a mounting position on a vehicle body, for example, vehicle panel 102 in mounting position 202 with respect to vehicle body 104 (as shown in FIG. 2). Method 1000 also includes removably coupling vehicle panel 102 to vehicle body 104 using a mounting jig, for example, mounting jig 318 (as shown in FIG. 5). In the exemplary embodiment, removably coupling vehicle panel 102 to vehicle body 104 includes aligning 1004 a first arm 506 located on a first mounting jig end 302 of mounting jig 318 with a first aperture 304 defined by a first edge surface 316 within vehicle body 104 and inserting first arm 506 into first aperture 304; aligning 1006 a first notch 510 on first arm 506 with a layer of material comprising first edge surface 316; pulling 1008 a handle 518 on a second mounting jig end 306 of mounting jig 318 to extend mounting jig 318; aligning 1010 a second arm 508 located on second mounting jig end 306 of mounting jig 318 with a second aperture 308 defined by a second edge surface 320 within vehicle panel 102 and inserting second arm 508 into second aperture 308; aligning 1012 a second notch 524 on second arm 508 with a layer of material comprising second edge surface 320; and releasing 1014 handle 518 to allow mounting jig 318 to compress and retain vehicle panel 102 in mounting position 202 with respect to vehicle body 104. Method 1000 also includes fastening vehicle panel 102 to vehicle body 104 using a door hinge, for example, first door hinge 106 (as shown in FIG. 1 and FIG. 4). In the exemplary embodiment, fastening 1016 vehicle panel 102 to vehicle body 104 includes installing a fastener through a through hole 404 defined within first door hinge 106 and into vehicle body 104. Method 1000 further includes removing mounting jig 318 from vehicle panel 102 and vehicle body 104. In the exemplary embodiment, removing mounting jig 318 includes pulling 1018 handle 518 to extend mounting jig 318 and pivoting mounting jig 318 to remove second arm 508 from second aperture 308; releasing 1020 handle 518 to allow mounting jig 318 to return to a fully compressed state; and removing 1022 first arm 506 from first aperture 304.

The foregoing detailed description of exemplary embodiments is included for illustrative purposes only. It should be understood that other embodiments could be used, or modifications and additions could be made to the described embodiments. Therefore, the disclosure is not limited to the embodiments shown, but rather should be construed in breadth and scope in accordance with the recitations of the appended claims.

What is claimed is:

1. A vehicle panel mounting jig, comprising:
a first block assembly including an outside first block end and an inside first block end, wherein a longitudinal axis of the mounting jig is defined as extending between the outside first block end and the inside first block end;
a first arm extending from the outside first block end of the first block assembly, substantially perpendicular to the longitudinal axis;
a second block assembly including an outside second block end, an inside second block end, and an opening defined within the inside second block end, wherein the inside first block end is configured for placement within the opening and to slide along the longitudinal axis relative to the second block assembly;
a second arm extending from the outside second block end of the second block assembly, substantially perpendicular to the longitudinal axis; and
a tension device coupling the first block assembly and the second block assembly.

2. The mounting jig of claim 1, wherein the first block assembly includes a handle at the outside first block end.

3. The mounting jig of claim 1, wherein the second block assembly includes a handle at the outside second block end.

4. The mounting jig of claim 1, wherein the tension device comprises one of: an extension spring, a hydraulic cylinder, and a pneumatic cylinder.

5. The mounting jig of claim 1, wherein the first arm includes a first notch defined therein.

6. The mounting jig of claim 1, wherein the second arm includes a second notch defined therein.

7. The mounting jig of claim 1, wherein the second block assembly includes a slot aperture defined therein.

8. The mounting jig of claim 7, wherein the first block assembly includes a protuberance located at a surface position corresponding to the slot aperture, and located at a first slot end when the mounting jig is in a fully extended state and a second slot end when the mounting jig is in a fully compressed state.

9. The mounting jig of claim 8, wherein the protuberance comprises a fastener head of a removable fastener extending from the first block assembly.

10. A mounting jig for temporarily retaining a vehicle panel onto a vehicle body, comprising:
a base block assembly including a first arm configured to insert into an aperture defined by a first edge surface in the vehicle body;
an extension assembly including an end that defines an opening configured to receive an end of and slide longitudinally relative to the base block assembly, a handle, and also a second arm configured to insert into an aperture defined by a second edge surface in the vehicle panel; and
an extension spring located in an internal cavity of the mounting jig and coupled at a first mounting jig end to the base block assembly and also coupled at a second mounting jig end to the extension assembly.

11. The mounting jig of claim 10, wherein the first arm includes a first notch defined therein.

12. The mounting jig of claim 10, wherein the second arm includes a second notch defined therein.

13. The mounting jig of claim 10, wherein the handle is mounted on a transverse face of the extension assembly.

14. The mounting jig of claim 10, wherein the extension assembly includes a longitudinal slot aperture defined therein, and the base block assembly includes a protuberance located at a position corresponding to the slot aperture wherein the protuberance is located at a first slot end when the mounting jig is in a fully extended state, and the protuberance is located at a second slot end when the mounting jig is in a fully compressed state.

15. The mounting jig of claim 14, wherein the protuberance comprises a bolt head of a bolt removably coupled to the base block assembly.

16. A method for coupling a vehicle panel to a vehicle body, comprising:
placing the vehicle panel in a mounting position on the vehicle body; and
temporarily securing the vehicle panel to the vehicle body, including:
aligning a first arm located on a first mounting jig end of a mounting jig with a first aperture defined by a first edge surface within the vehicle body and inserting the first arm into the first aperture; and
aligning a second arm located on a second mounting jig end of the mounting jig with a second aperture defined by a second edge surface within the vehicle panel and inserting the second arm into the second aperture.

17. The method of claim 16, including:
fastening the vehicle panel to the vehicle body, comprising installing a fastener to couple a first hinge end of a door hinge and the vehicle body, wherein a second hinge end of the door hinge is coupled to the vehicle panel; and
removing the mounting jig from the vehicle body and the vehicle panel, including:
pivoting the mounting jig to remove the second arm from the second aperture; and
removing the first arm from the first aperture.

18. The method of claim 16, wherein temporarily securing the vehicle panel to the vehicle body includes:
pulling a handle on the second mounting jig end of the mounting jig to extend the mounting jig prior to aligning the second arm with the second aperture; and
releasing the handle after inserting the second arm into the second aperture to allow the mounting jig to compress to a compressed state and retain the vehicle panel in the mounting position against the vehicle body.

19. The method of claim 18, including:
fastening the vehicle panel to the vehicle body, comprising installing a fastener to couple a first hinge end of a door hinge and the vehicle body, wherein a second hinge end of the door hinge is coupled to the vehicle panel; and
removing the mounting jig from the vehicle body and the vehicle panel, including:
pulling the handle to extend the mounting jig;
pivoting the mounting jig to remove the second arm from the second aperture;
releasing the handle to allow the mounting jig to compress to a fully compressed state; and
removing the first arm from the first aperture.

20. The method of claim 18, wherein temporarily securing the vehicle panel to the vehicle body includes:
aligning a first notch defined within the first arm with a layer of material comprising the first edge surface of the first aperture after inserting the first arm into the first aperture; and
aligning a second notch defined within the second arm with a layer of material comprising the second edge surface of the second aperture after inserting the second arm into the second aperture.
